(19) United States
(12) Patent Application Publication
(10) Pub. No.: US 2008/0004969 A1
(43) Pub. Date: Jan. 3, 2008

(54) System and methods for anonymous transactions in non-fungible goods

(75) Inventors: Mordekhay Shniberg, New York, NY (US); Dan Galai, Jerusalem (IL); Ayal Brenner, New York, NY (US)

Correspondence Address: DARBY & DARBY P.C., P.O. BOX 770, Church Street Station, New York, NY, 10008-0770, US

(73) Assignee: MUTUALART INC., New York, NY (US)

(21) Appl. No.: 11/454,077

(22) Filed: Jun. 14, 2006

(51) Int. Cl. G06Q 30/00

(52) U.S. Cl. 705/26

(57) ABSTRACT

A method for anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and establishing contact with at least one of potential buyers and sellers.

### BACKGROUND OF THE INVENTION

The following U.S. Patents are believed to represent the current state of the art: U.S. Pat. Nos. 6,904,410 and 5,911,131.

### FIELD OF THE INVENTION

The present invention relates to business methods and systems for facilitating commerce in non-fungible goods, such as works of fine art.

### SUMMARY OF THE INVENTION

The present invention provides new and enhanced business methods and systems for facilitating commerce in non-fungible goods, such as works of fine art. There is thus provided in accordance with a preferred embodiment of the present invention a method for anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and establishing contact with at least one of potential buyers and sellers.

In accordance with a preferred embodiment of the present invention the particulars include at least one of identification of the non-fungible goods by title, artist identifiers, date identifiers, period identifiers, condition identifiers and provenance identifiers.

In accordance with another preferred embodiment of the present invention the entering also includes entering into the database at least one of a price at which the potential sellers would be willing to sell the non-fungible goods and an identification of other non-fungible goods for which the potential sellers would be willing to trade the non-fungible goods. Preferably, the employing includes employing the database to generate an anonymous virtual catalog of non-fungible goods and making at least part of the anonymous virtual catalog available to the at least one of potential buyers and sellers.

In accordance with yet another preferred embodiment of the present invention the establishing contact includes establishing contact between the potential buyers and the potential sellers via at least one intermediary. Preferably, the at least one intermediary includes an operator of the database. Additionally or alternatively, the entering includes communicating the particulars to the database via a network.

In accordance with still another preferred embodiment of the present invention the at least one of potential buyers and sellers includes at least one of collectors, museums and dealers in non-fungible goods. Preferably, the non-fungible goods include works of fine art. Additionally or alternatively, the establishing contact includes providing to the potential buyers identifying information for the potential sellers.

There is also provided in accordance with another preferred embodiment of the present invention a method for double-blind anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and establishing contact with at least one of potential buyers and sellers through a double blind intermediary.

In accordance with a preferred embodiment of the present invention the particulars include at least one of identification of the non-fungible goods by title, artist identifiers, date identifiers, period identifiers, condition identifiers and provenance identifiers. Preferably, the entering also includes entering into the database at least one of a price at which the potential sellers would be willing to sell the non-fungible goods and an identification of other non-fungible goods for which the potential sellers would be willing to trade the non-fungible goods.

In accordance with another preferred embodiment of the present invention the entering includes communicating the particulars to at least one trusted intermediary and entering the particulars into the database by the at least one trusted intermediary. Preferably, the communicating also includes communicating to the at least one trusted intermediary the identifiers of the at least one of potential buyers and sellers.

In accordance with yet another preferred embodiment of the present invention the employing includes employing the database to generate an anonymous virtual catalog of non-fungible goods and making at least part of the anonymous virtual catalog available to the at least one of potential buyers and sellers. Preferably, the making includes making the at least part of the anonymous virtual catalog available to at least one trusted intermediary of the at least one of potential buyers and sellers.

In accordance with still another preferred embodiment of the present invention at the least one of potential buyers and sellers includes at least one of collectors, museums and dealers in non-fungible goods. Preferably, the non-fungible goods include works of fine art.

There is further provided in accordance with still another preferred embodiment of the present invention a method for anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and guaranteeing the transaction using at least one fiduciary.

In accordance with a preferred embodiment of the present invention the particulars include at least one of identification of the non-fungible goods by title, artist identifiers, date identifiers, period identifiers, condition identifiers and provenance identifiers. Preferably the entering also includes entering into the database at least one of a price at which the potential sellers would be willing to sell the non-fungible goods and an identification of other non-fungible goods for which the potential sellers would be willing to trade the non-fungible goods.

In accordance with another preferred embodiment of the present invention the employing includes employing the database to generate an anonymous virtual catalog of non-fungible goods and making at least part of the anonymous virtual catalog available to the at least one of potential buyers and sellers. Preferably, the at least one of potential buyers and sellers includes at least one of collectors, museums and dealers in non-fungible goods. Additionally or alternatively, the non-fungible goods include works of fine art.

In accordance with still another preferred embodiment of the present invention the guaranteeing includes providing the non-fungible goods to the at least one fiduciary by a selling party and providing funds for the non-fungible goods to the at least one fiduciary by a buying party. Preferably, the at least one fiduciary includes an operator of the database.

In accordance with a further preferred embodiment of the present invention the entering includes communicating the particulars to the database via a network. Preferably, the guaranteeing includes the at least one fiduciary providing identifying information of a buying party of the non-fungible goods to a selling party thereof.

There is still further provided in accordance with a preferred embodiment of the present invention a method for double-blind anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and guaranteeing the transaction using at least two double-blind fiduciaries.

In accordance with a preferred embodiment of the present invention the particulars include at least one of identification of the non-fungible goods by title, artist identifiers, date identifiers, period identifiers, condition identifiers and provenance identifiers. Preferably, the entering also includes entering into the database at least one of a price at which the potential sellers would be willing to sell the non-fungible goods and an identification of other non-fungible goods for which the potential sellers would be willing to trade the non-fungible goods.

In accordance with another: preferred embodiment of the present invention the entering includes communicating the particulars to at least one trusted intermediary and entering the particulars into the database by the at least one trusted intermediary. Preferably, the communicating also includes communicating to the at least one trusted intermediary the identifiers of the at least one of potential buyers and sellers.

In accordance with still another preferred embodiment of the present invention the employing includes employing the database to generate an anonymous virtual catalog of non-fungible goods and making at least part of the anonymous virtual catalog available to the at least one of potential buyers and sellers. Preferably, the making includes making the at least part of the anonymous virtual catalog available to at least one trusted intermediary of the at least one of potential buyers and sellers.

In accordance with yet another preferred embodiment of the present invention the at least one of potential buyers and sellers includes at least one of collectors, museums and dealers in non-fungible goods. Preferably, the non-fungible goods include works of fine art. Additionally or alternatively, the guaranteeing includes providing the non-fungible goods to a first of the at least two double blind fiduciaries by a selling party, providing funds for the non-fungible goods to a second of the at least two double blind fiduciaries by a buying party and exchanging the non-fungible goods and the funds between the first and second of the at least two double blind fiduciaries.

There is additionally provided in accordance with an additional preferred embodiment of the present invention a method for computerized appraisal of unique items of art, the method including entering particulars of at least one unique item of art held by at least one collector into a database, which particulars include at least one of artist identifiers, date identifiers and relevant recent sale histories of related items of art without entering into the database identifiers of the at least one collector and employing at least one formula for computerized appraisal of the at least one unique item of art.

In accordance with a preferred embodiment of the present invention the particulars of the at least one unique item of art include at least one of identification of the unique item of art by title, artist identifiers, date identifiers, period identifiers, condition identifiers and provenance identifiers. Preferably, the entering includes communicating the particulars of the at least one unique item of art to the database via a network.

In accordance with another preferred embodiment of the present invention the method also includes prior to the entering, obtaining the relevant recent sale histories of related items of art from at least one of treatises and journals. Preferably, the method also includes, prior to the employing at least one formula, comparing the particulars of the at least one unique item of art with at least one of previously obtained particulars of related items of art, recent sale history of the at least one unique item of art, particulars of other items of art of the artist who created the at least one unique item of art and the relevant recent sale histories of related items of art and calculating an average appreciation of the related items of art.

In accordance with yet another preferred embodiment of the present invention the at least one formula includes the steps of multiplying an average price of the other items of art of the artist in the same medium as the at least one unique item of art by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with still another preferred embodiment of the present invention the at least one formula includes the steps of multiplying an average price of other items of art in the same medium and created in the same year as the at least one unique item of art but created by an artist other than the artist by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with a further preferred embodiment of the present invention the at least one formula includes multiplying a metric representing a price at which the at least one unique item of art has been sold in the past by a metric representing an average of sale prices of other items of art created by the artist sold since a previous sale of the at least one unique item of art.

There is also provided in accordance with another preferred embodiment of the present invention a method for double-blind computerized appraisal of unique items of art, the method including entering particulars of at least one unique item of art held by at least one collector into a database, which particulars include at least one of artist identifiers, date identifiers and relevant recent sale histories of related items of art using at least one double-blind fiduciary and employing at least one formula for computerized appraisal of the at least one unique item of art.

In accordance with a preferred embodiment of the present invention the particulars of the at least one unique item of art include at least one of identification of the unique item of art by title, artist identifiers, date identifiers, period identifiers, condition identifiers and provenance identifiers. Preferably, identifiers of the at least one collector are not entered into the database.

In accordance with another preferred embodiment of the present invention the entering includes communicating the particulars to the at least one double-blind fiduciary and entering the particulars into the database by the at least one double-blind fiduciary. Preferably, the communicating also includes communicating to the at least one double-blind the identifiers of the at least one collector.

In accordance with yet another preferred embodiment of the present invention the entering includes communicating the particulars of the at least one unique item of art to the database via a network. Preferably, the method also includes, prior to the entering, obtaining the relevant recent sale histories of related items of art from at least one of treatises and journals.

In accordance with still another preferred embodiment of the present invention the method also includes, prior to the employing at least one formula, comparing the particulars of the at least one unique item of art with at least one of previously obtained particulars of related items of art, recent sale history of the at least one unique item of art, particulars of other items of art of the artist who created the at least one unique item of art and the relevant recent sale histories of related items of art and calculating an average appreciation of the related items of art.

In accordance with a further preferred embodiment of the present invention the at least one formula includes the steps of multiplying an average price of the other items of art of the artist in the same medium as the at least one unique item of art by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with yet a further preferred embodiment of the present invention the at least one formula includes the steps of multiplying an average price of other items of art in the same medium and created in the same year as the at least one unique item of art but created by an artist other than the artist by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with a still further preferred embodiment of the present invention the at least one formula includes multiplying a metric representing a price at which the at least one unique item of art has been sold in the past by a metric representing an average of sale prices of other items of art created by the artist sold since a previous sale of the at least one unique item of art.

There is further provided in accordance with a further preferred embodiment of the present invention a method for computerized appraisal of unique items of art and insurance coverage thereof, the method including entering particulars of at least one unique item of art held by at least one collector into a database, which particulars include at least one of artist identifiers, date identifiers and relevant recent sale histories of related items of art, without entering into the database identifiers of the at least one collector, employing at least one formula for computerized appraisal of the at least one unique item of art and employing the computerized appraisal for establishing insurance coverage of the at least one unique item of art, wherein the identifiers of the at least one collector are not provided to a provider of the insurance coverage.

In accordance with a preferred embodiment of the present invention the entering includes communicating to the at least one trusted intermediary the identifiers of the at least one collector. Preferably, the particulars of the at least one unique item of art include at least one of identification of the at least one unique item of art by title, artist identifier, date identifier, period identifier, condition identifier and provenance identifier.

In accordance with another preferred embodiment of the present invention the entering includes communicating the particulars of the at least one unique item of art to the database via a network. Preferably, the method also includes, prior to the entering, obtaining the relevant recent sale histories of related items of art from at least one of treatises and journals.

In accordance with still another preferred embodiment of the present invention the method also includes, prior to the employing at least one formula, comparing the particulars of the at least one unique item of art with at least one of previously obtained particulars of related items of art, recent sale history of the at least one unique item of art, particulars of other items of art of the artist who created the at least one unique item of art and the relevant recent sale histories of related items of art and calculating an average appreciation of the related items of art.

In accordance with yet another preferred embodiment of the present invention the at least one formula includes the steps of multiplying an average price of the other items of art of the artist in the same medium as the at least one unique item of art by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with a further preferred embodiment of the present invention the at least one formula includes the steps of multiplying an average price of other items of art in the same medium and created in the same year as the at least one unique item of art but created by an artist other than the artist by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with yet a further preferred embodiment of the present invention the at least one formula includes multiplying a metric representing a price at which the at least one unique item of art has been sold in the past by a metric representing an average of sale prices of other items of art created by the artist sold since a previous sale of the at least one unique item of art.

There is additionally provided in accordance with yet another preferred embodiment of the present invention a method for anonymous insurance coverage of unique items, the method including entering particulars of at least one unique item of art held by at least one collector into a database, including at least one of artist identifiers, date identifiers and relevant recent sale histories of related items of art, without providing to the database identifiers of the at least one collector, employing at least one formula for computerized appraisal of the at least one unique item of art, employing the computerized appraisal for establishing insurance coverage of the at least one unique item of art, including establishing an insurance contract for the at least one unique item of art through at least one double blind intermediary, trusted by at least one party to the insurance contract.

In accordance with a preferred embodiment of the present invention the entering includes communicating the particulars of the at least one unique item of art to the at least one double blind intermediary and entering the particulars of the at least one unique item of art into the database by the at least one double blind intermediary. Preferably, the communicating also includes communicating the identifiers of the at least one collector to the at least one double blind intermediary.

In accordance with another preferred embodiment of the present invention the particulars of the at least one unique item of art include at least one of identification of the unique item of art by title, artist identifiers, date identifiers, period identifiers, condition identifiers and provenance identifiers. Preferably, the entering includes communicating the particulars of the at least one unique item of art to the database via a network.

In accordance with yet another preferred embodiment of the present invention the method also includes, prior to the entering, obtaining the relevant recent sale histories of related items of art from at least one of treatises and journals. Preferably, the method also includes, prior to the employing at least one formula, comparing the particulars of the at least one unique item of art with at least one of previously obtained particulars of related items of art, recent sale history of the at least one unique item of art, particulars of other items of art of the artist who created the at least one unique item of art and the relevant recent sale histories of related items of art and calculating an average appreciation of the related items of art.

In accordance with still another preferred embodiment of the present invention the at least one formula includes the steps of multiplying an average price of the other items of art of the artist in the -same medium as the at least one unique item of art by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with a further preferred embodiment of the present invention the at least one formula includes the steps of multiplying an average price of other items of art in the same medium and created in the same year as the at least one unique item of art but created by an artist other than the artist by a metric representing the size of the at least one unique item of art to give a first result, multiplying a number of sales of the at least one unique item of art by a metric representing an average size of the other items of art of the artist in the same medium to give a second result and dividing the first result by the second result.

In accordance with yet a further preferred embodiment of the present invention the at least one formula includes multiplying a metric representing a price at which the at least one unique item of art has been sold in the past by a metric representing an average of sale prices of other items of art created by the artist sold since a previous sale of the at least one unique item of art.

### BRIEF DESCRIPTION OF THE DRAWINGS

The present invention will be understood and appreciated more fully from the following detailed description, taken in conjunction with the drawings in which:

FIG. 1A is a simplified pictorial illustration of a system and methodology for providing information as to the existence and/or availability of non-fungible goods, such as works of fine art, to potential purchasers without disclosing information relating to the ownership of such non-fungible goods;

FIG. 1B is a simplified pictorial illustration of a double-blind system and methodology for providing information as to the existence and/or availability of non-fungible goods, such as works of fine art, to potential purchasers;

FIG. 2A is a simplified pictorial illustration of a system and methodology for effecting transfer of ownership of and payment for non-fungible goods, such as works of fine art, without disclosing information relating to the ownership of such non-fungible goods;

FIG. 2B is a simplified pictorial illustration of a double-blind system and methodology for effecting transfer of ownership of and payment for non-fungible goods, such as works of fine art;

FIG. 3A is a simplified pictorial illustration of a system and methodology for automated appraisal of non-fungible goods, such as works of fine art, without disclosing information relating to the ownership of such non-fungible goods.

FIG. 3B is a simplified pictorial illustration of a double-blind system and methodology for automated appraisal of non-fungible goods, such as works of fine art;

FIG. 4A is a simplified pictorial illustration of a system and methodology for effecting insurance of non-fungible goods, such as works of fine art, based on automated appraisal without disclosing information relating to the ownership of such non-fungible goods;

FIG. 4B is a simplified pictorial illustration of a double-blind system and methodology for effecting insurance of non-fungible goods, such as works of fine art, based on automated appraisal;

FIG. 5 is a simplified flowchart illustrating functionality employed in the embodiment of FIGS. 1A and 1B;

FIG. 6 is a simplified flowchart illustrating functionality employed in the embodiment of FIGS. 2A and 2B;

FIG. 7 is a simplified flowchart illustrating functionality employed in the embodiment of FIGS. 3A and 3B; and

FIG. 8 is a simplified flowchart illustrating functionality employed in the embodiment of FIGS. 4A and 4B.

### DETAILED DESCRIPTION OF PREFERRED EMBODIMENTS

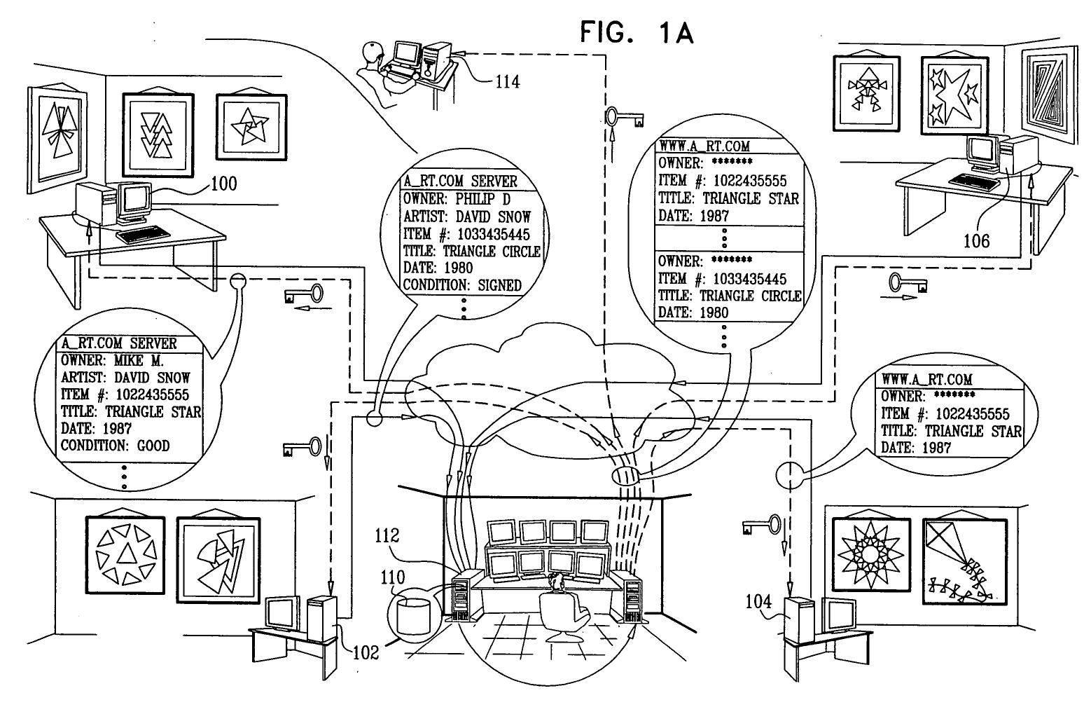

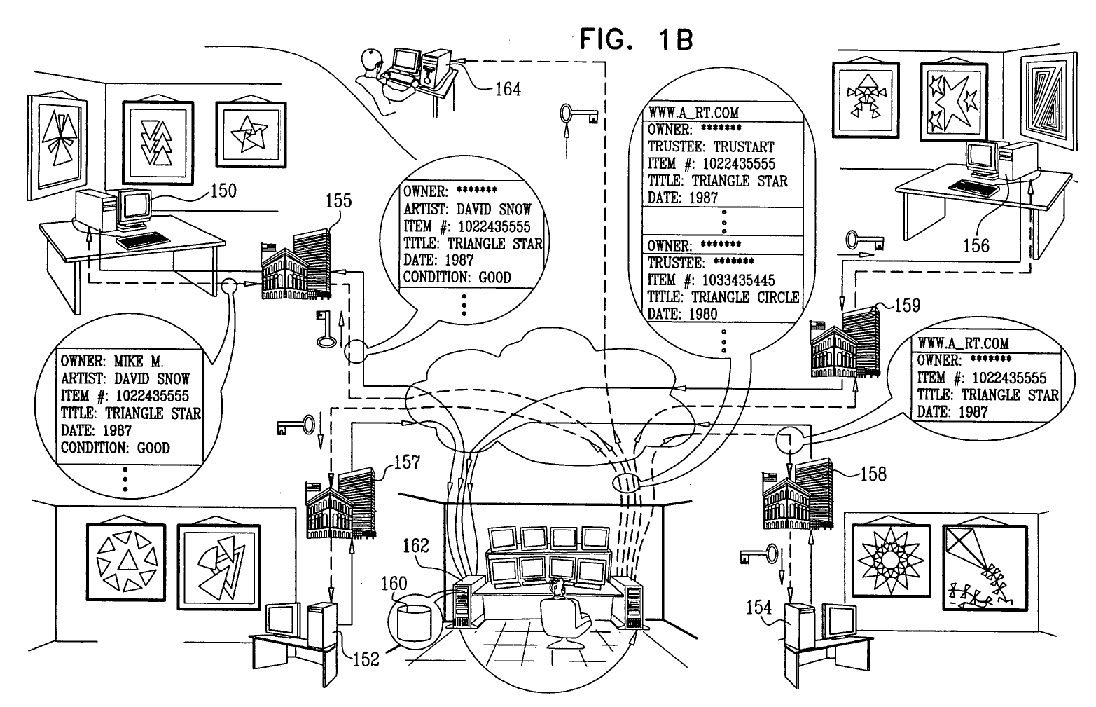

Reference is now made to FIG. 1A, which is a simplified pictorial illustration of a system and methodology for providing information as to the existence and/or availability of non-fungible goods, such as works of fine art, to potential purchasers without disclosing information relating to the ownership of such non-fungible goods and to FIG. 1B, which is a simplified pictorial illustration of a double-blind system and methodology for providing information as to the existence and/or availability of non-fungible goods, such as works of fine art, to potential purchasers.

As shown generally in FIG. 1A, there is provided a method for anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and establishing contact with at least one of potential buyers and sellers.

As seen in FIG. 1A, a plurality of collectors, using respective computers 100, 102, 104 and 106 communicate via a computer network, such as the Internet, with one or more central databases 110 residing on one or more servers 112. They preferably provide to the database 110 particulars of the non-fungible goods, here, for example, works of fine art, in their collections. These particulars may include, for example, identification of the works by title, artist and date or period, the condition of the work and the provenance thereof. The collectors may indicate a price at which they would be willing to sell one or more works and/or one or more works that they would be willing to trade therefor. They may or may not provide information which indicates their identity or location.

The database 110 is preferably employed to generate an anonymous virtual catalog which may be pushed or otherwise made available via the computer network to the collectors who provided the particulars of the works in their collections to the database, via computers 100, 102, 104 and 106, and/or to other entities, such as, for example, dealers and museums, via computer 114. The entire catalog need not be made available to all entities. For example, some entities may wish to receive information only regarding works of specific artists or belonging to specific periods.

Inasmuch as the information regarding the owners of the works is not made available to the viewer of the catalog, who may be a potential buyer of the works, contact between the owners of the works and the viewers of the catalog is preferably carried out by the operators of the database 110. This may be done by disclosing the identity of the viewer of the catalog to the owner, or, preferably, entirely anonymously through one or more intermediaries, who, preferably, are affiliated with the operators of the database, but need not necessarily be.

Reference is now made to FIG. 1B, which is a simplified pictorial illustration of a double-blind system and methodology for providing information as to the existence and/or availability of non-fungible goods, such as works of fine art, to potential purchasers.

As shown generally in FIG. 1B, there is provided a method for double-blind anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and establishing contact with at least one of potential buyers and sellers through a double blind intermediary.

As seen in FIG. 1B, a plurality of collectors, using respective computers 150, 152, 154 and 156 communicate via a computer network, such as the Internet, with respective trusted intermediaries 155, 157, 158 and 159, such as fiduciaries or trustees. These trusted intermediaries communicate in turn via the same or a different computer network with one or more central databases 160 residing on one or more servers 162. The collectors preferably provide to their respective trusted intermediaries 155, 157, 158 and 159 particulars of the non-fungible goods, here, for example, works of fine art, in their collections. These particulars may include, for example, identification of the works by title, artist and date or period, the condition of the work and the provenance thereof. The collectors may indicate a price at which they would be willing to sell one or more works and/or one or more works that they would be willing to trade therefor. They preferably provide to their trusted intermediaries information which indicates their identity and the location of the works.

It is appreciated that the trusted intermediaries 155, 157, 158 and 159 are trusted by the collectors and a single intermediary may act as a trusted intermediary for more than one collector. The trusted intermediaries preferably provide to the database 160 particulars of the non-fungible goods, here, for example, works of fine art, in the collections of their respective collector clients. These particulars may include, for example, identification of the works by title, artist and date or period, the condition of the work, the provenance thereof and a price at which the collectors would be willing to sell one or more works and/or one or more works that they would be willing to trade therefor. They do not provide information which indicates the identity and/or location of their collector clients.

The database 160 is preferably employed to generate an anonymous virtual catalog which may be pushed or otherwise made available via the computer network to the collectors who provided the particulars of the works in their collections to the database, preferably not directly but instead via intermediaries 155, 157, 158 and 159, and/or to other entities, such as, for example, dealers and museums, typically via a computer 164. The entire catalog need not be made available to all entities. For example, some entities may wish to receive information only regarding works of specific artists or belonging to specific periods.

Inasmuch as the information regarding the owners of the works is not made available to the viewer of the catalog, who may be a potential buyer of the works, contact between the owners of the works and the viewers of the catalog is preferably carried out by the operators of the database 210 via the trusted intermediaries. This may be done by disclosing the respective identities of the trusted intermediaries of the viewer of the catalog and of the owner, or, preferably, entirely anonymously through the trusted intermediaries via the operators of the database.

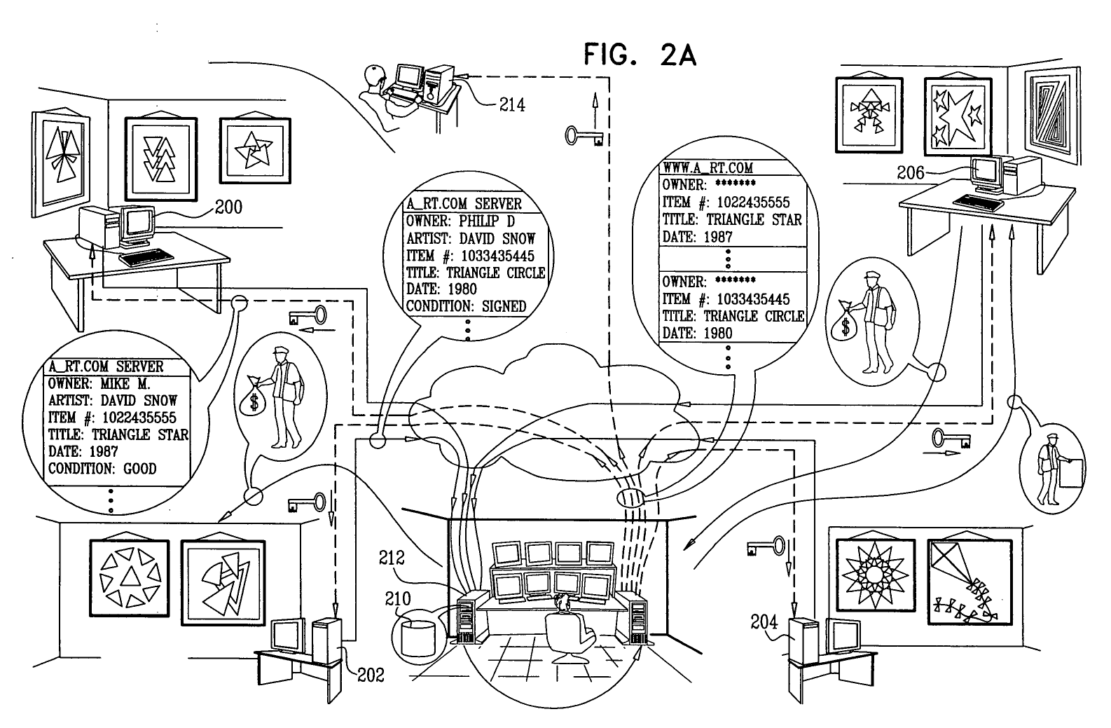

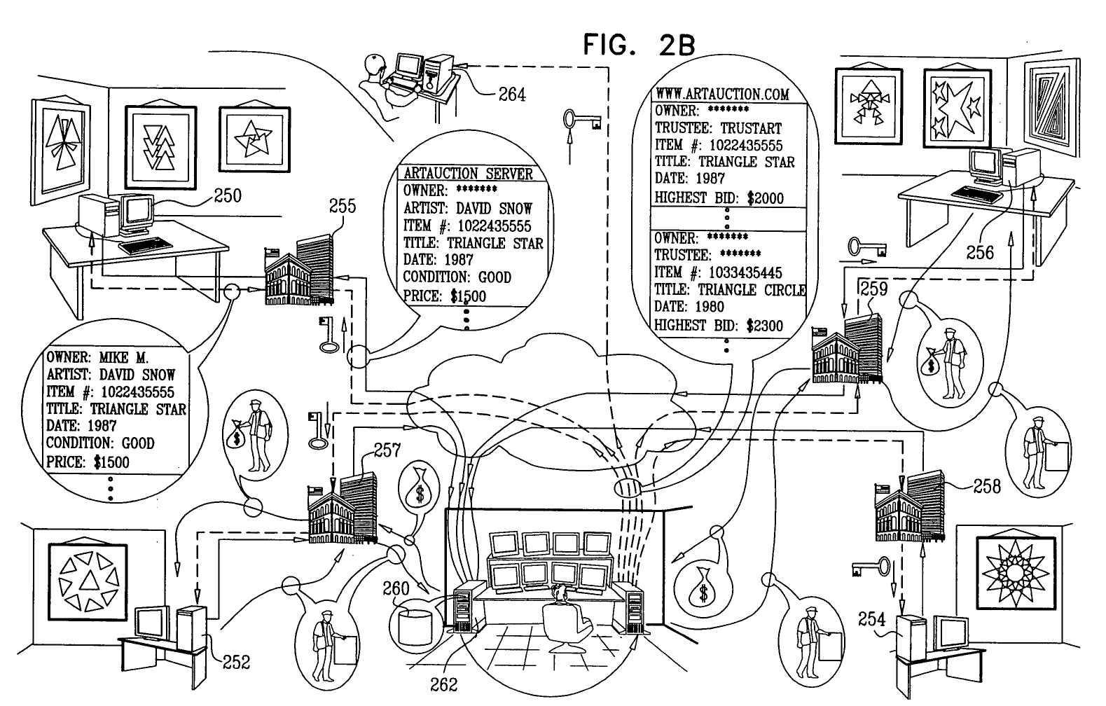

Reference is now made to FIG. 2A, which is a simplified pictorial illustration of a system and methodology for effecting transfer of ownership of and payment for non-fungible goods, such as works of fine art, without disclosing information relating to the ownership of such non-fungible goods and to FIG. 2B, which is a simplified pictorial illustration of a double-blind system and methodology for effecting transfer of ownership of and payment for non-fungible goods, such as works of fine art.

As shown generally in FIG. 2A, there is provided A method for anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and guaranteeing the transaction using at least one fiduciary.

As seen in FIG. 2A, a plurality of collectors, using respective computers 200, 202 and 204 communicate via a computer network, such as the Internet, with one or more central databases 210 residing on one or more servers 212. They preferably provide to the database 210 particulars of the non-fungible goods, here, for example, works of fine art, in their collections. These particulars may include, for example, identification of the works by title, artist and date or period, the condition of the work and the provenance thereof. The collectors may indicate a price at which they would be willing to sell one or more works and/or one or more works that they would be willing to trade therefor. They may or may not provide information which indicates their identity or the location of the works.

The database 210 is preferably employed to match potential buyers with potential sellers in any suitable type of commercial framework such as an auction or two-party negotiation.

Optionally, the database 210 may be employed to generate an anonymous virtual catalog which may be pushed or otherwise made available via the computer network to the collectors who provided the particulars of the works in their collections to the database, such as, for example, dealers and museums, typically via a computer 214. The entire catalog need not be made available to all entities. For example, some entities may wish to receive information only regarding works of specific artists or belonging to specific periods.

Inasmuch as the information regarding the owners of the works is not made available to the purchaser, consummation of a sale or trade transaction is preferably carried out by the operators of the database 210. This may be done by disclosing the identity of the purchaser to the seller or preferably entirely anonymously through one or more intermediaries, who preferably are affiliated with the operators of the database, but need not necessarily be. The intermediary may provide necessary escrow and/or financial guarantees for the transaction and may handle the logistics thereof, as well.

Reference is now made to FIG. 2B, which is a simplified pictorial illustration of a double-blind system and methodology for effecting transfer of ownership of and payment for non-fungible goods, such as works of fine art.

As shown generally in FIG. 2B, there is provided a method for double-blind anonymous computerized commerce in non-fungible goods, the method including entering into a database particulars of non-fungible goods held by at least one of potential buyers and sellers, without providing to the database identifiers of the at least one of potential buyers and sellers, employing the database to match potential buyers with potential sellers of non-fungible goods based on similarities between non-fungible goods at least potentially available for sale by potential sellers and non-fungible goods held by potential buyers and guaranteeing the transaction using at least two double-blind fiduciaries.

As seen in FIG. 2B, a plurality of collectors, using respective computers 250, 252, 254 and 256 communicate via a computer network, such as the Internet, with respective trusted intermediaries 255, 257, 258 and 259, such as fiduciaries or trustees. These trusted intermediaries communicate in turn via the same or a different computer network with one or more central databases 260 residing on one or more servers 262. The collectors preferably provide to their respective trusted intermediaries 255, 257, 258 and 259 particulars of the non-fungible goods, here, for example, works of fine art, in their collections. These particulars may include, for example, identification of the works by title, artist and date or period, the condition of the work and the provenance thereof. The collectors may indicate a price at which they would be willing to sell one or more works and/or one or more works that they would be willing to trade therefor. They preferably provide to their trusted intermediaries information which indicates their identity and the location of the works.

It is appreciated that the trusted intermediaries 255, 257, 258 and 259 are trusted by the collectors and a single intermediary may act as a trusted intermediary for more than one collector. The trusted intermediaries preferably provide to the database 260 particulars of the non-fungible goods, here, for example, works of fine art, in the collections of their respective collector clients. These particulars may include, for example, identification of the works by title, artist and date or period, the condition of the work, the provenance thereof and a price at which the collectors would be willing to sell one or more works and/or one or more works that they would be willing to trade therefor. They do not provide information which indicates the identity and/or location of their collector clients.

Optionally, the database 260 may be employed to generate an anonymous virtual catalog which may be pushed or otherwise made available via the computer network to the collectors who provided the particulars of the works in their collections to the database, preferably not directly but instead via intermediaries 255, 257, 258 and 259, and/or to other entities, such as, for example, dealers and museums, typically via a computer 264. The entire catalog need not be made available to all entities. For example, some entities may wish to receive information only regarding works of specific artists or belonging to specific periods.

Inasmuch as the information regarding the owners of the works is not made available to the purchaser, consummation of a sale or trade transaction is preferably carried out by the operators of the database 260 via the trusted intermediaries. This may be done by disclosing the identity of the trusted intermediaries to either or both the trusted intermediaries of the purchaser and the seller or, alternatively, via the operators of the database. One or more of the trusted intermediaries and the operator of the database may provide necessary escrow and/or financial guarantees for the transaction and may handle the logistics thereof, as well.

In accordance with a preferred embodiment of the present invention at least two double-blind fiduciaries, preferably the trusted intermediaries of the seller and the buyer, are used to guarantee the transaction via the database operator.

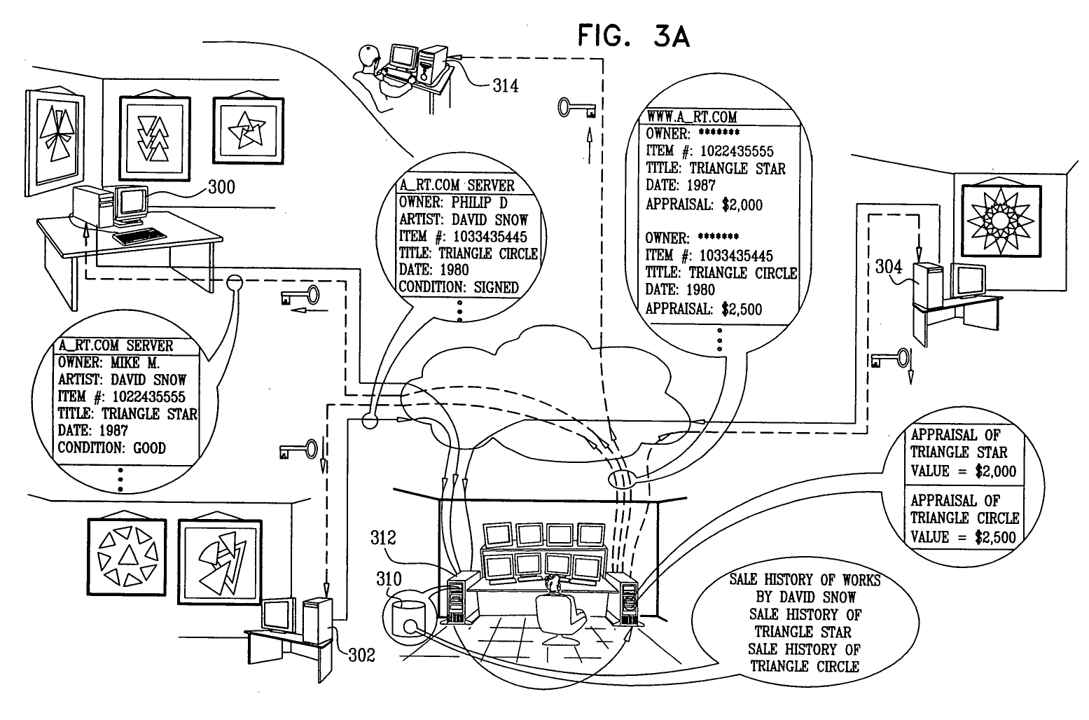

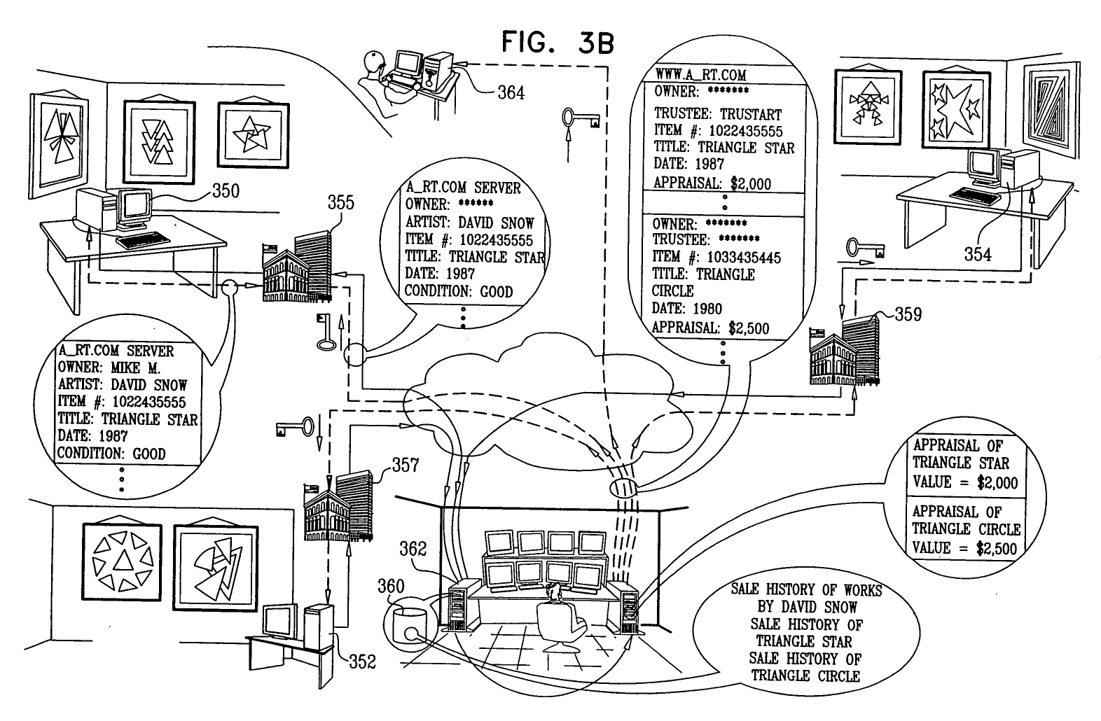

Reference is now made to FIG. 3A, which is a simplified pictorial illustration of a system and methodology for automated appraisal of non-fungible goods, such as works of fine art, without disclosing information relating to the ownership of such non-fungible goods and to FIG. 3B, which is a simplified pictorial illustration of a double-blind system and methodology for automated appraisal of non-fungible goods, such as works of fine art.

As shown generally in FIG. 3A, there is provided a method for computerized appraisal of unique items of art, the method including entering particulars of at least one unique item of art held by at least one collector into a database, which particulars include at least one of artist identifiers, date identifiers and relevant recent sale histories of related items of art without entering into the database identifiers of the at least one collector and employing at least one formula for computerized appraisal of the at least one unique item of art.

As seen in FIG. 3A, a plurality of collectors, using respective computers 300, 302 and 304 communicate via a computer network, such as the Internet, with one or more central databases 310 residing on one or more servers 312. They preferably provide to the database 310 particulars of the non-fungible goods, here, for example, works of fine art, in their collections. These particulars may include, for example, identification of the works by title, artist and date or period, the condition of the work, its dimensions and the provenance thereof. The collectors may indicate a price at which they would be willing to sell one or more works and/or one or more works that they would be willing to trade therefor. They may or may not provide information which indicates their identity or the location of the works. The database 310 preferably also contains publicly available information, such as from treatises and journals, which may be relevant to the valuation of a work or collection of works.

The database 310 is preferably employed by an art appraisal algorithm which employs the information contained therein to automatically generate an appraisal of one or more works in the database. Preferably, a user provides input information regarding the work of art, such as the artist name, title, size, shape, medium of the artwork date or period, provenance of the art work, purchase date and price, and an indication whether the artwork is signed.

The input information is preferably compared to sale history data contained in the database, which may include the previous sale history of the artwork, the previous sale history of works by the same artist and previous sale history of works by comparable artists. An average appreciation of works by the artist or by similar artists, and of works in similar medium are calculated from these comparisons.

Preferably, the algorithm of the present invention employs one of a plurality of evaluation formulas, based on the information input by the user and on the publicly available information in the database.

In accordance with one example of a possible evaluation formula, the average price of other works in the same medium by the same artist which were sold during the year of appraisal is multiplied by the size of the artwork, and the product is divided by the multiplication of the number of times the work has been sold by the average size of works in the same medium by the same artist. The resulting value is the appraisal value of the artwork.

In accordance with another example of a possible evaluation formula, the average price of works in the same medium but by different artists, which were produced in the same year as the appraised artwork and sold during the year of appraisal is multiplied by the size of the artwork. The resulting product is divided by the multiplication of the number of times the work has been sold by the average size of works in the same medium by the same artist. The resulting value is the appraisal value of the artwork.

In accordance with yet another example of a possible evaluation formula, the price at which the artwork was sold in the past is multiplied by an average appreciation of sale prices of works by the same artist which were sold since the last time the appraised work was sold, and the resulting product is the appraisal value of the artwork.

Inasmuch as the appraisal need not be based on information regarding the current owners of the works or the location of the works, it can be carried out anonymously and without interaction with the owners of the works or disclosure by the owners of their identity and/or location. This may be done by channeling information regarding the works through one or more intermediaries, who preferably are affiliated with the operators of the database, but need not necessarily be. The intermediary should be trusted by both the owner of the work and by the operator of the database in order to enhance credibility of the resulting appraisal.

Optionally, the database 310 may be employed to generate an anonymous virtual catalog, including the resulting appraisals of the works in the catalog, which may be pushed or otherwise made available via the computer network to the collectors who provided the particulars of the works in their collections to the database, such as, for example, dealers and museums, typically via a computer 314. The entire catalog need not be made available to all entities. For example, some entities may wish to receive information only regarding works of specific artists or belonging to specific periods.

Reference is now made to FIG. 3B, which is a simplified pictorial illustration of a double-blind system and methodology for automated appraisal of non-fungible goods, such as works of fine art.

As shown generally in FIG. 3B, there is provided a method for double-blind computerized appraisal of unique items of art, the method including entering particulars of at least one unique item of art held by at least one collector into a database, which particulars include at least one of artist identifiers, date identifiers and relevant recent sale histories of related items of art using at least one double-blind fiduciary and employing at least one formula for computerized appraisal of the at least one unique item of art.

As seen in FIG. 3B, a plurality of collectors, using respective computers 350, 352 and 354 communicate via a computer network, such as the Internet, with respective trusted intermediaries 355, 357 and 359, such as fiduciaries or trustees. These trusted intermediaries communicate in turn via the same or a different computer network with one or more central databases 360 residing on one or more servers 362. The collectors preferably provide to their respective trusted intermediaries 355, 357 and 359 particulars of the non-fungible goods, here, for example, works of fine art, in their collections. These particulars may include, for example, identification of the works by title, artist and date or period, the condition of the work, the size of the work, the medium and the provenance thereof. The collectors may indicate a price at which they would be willing to sell one or more works and/or one or more works that they would be willing to trade therefor. They preferably provide to their trusted intermediaries information which indicates their identity and the location of the works.

It is appreciated that the trusted intermediaries 355, 357 and 359 are trusted by the collectors and a single intermediary may act as a trusted intermediary for more than one collector. The trusted intermediaries preferably provide to the database 360 particulars of the non-fungible goods, here, for example, works of fine art, in the collections of their respective collector clients. These particulars may include, for example, identification of the works by title, artist and date or period, the condition of the work, size of the work, the medium and the provenance thereof and a price at which the collectors would be willing to sell one or more works and/or one or more works that they would be willing to trade therefor. They do not provide information which indicates the identity and/or location of their collector clients.

The database 360 is preferably employed by an art appraisal algorithm which employs the information contained therein to automatically generate an appraisal of one or more works in the database. Preferably, a user provides input information regarding the work of art, such as the artist name, title, size, shape, medium of the artwork, date or period, provenance of the art work, purchase date and price, and an indication whether the artwork is signed.

The input information is preferably compared to sale history data contained in the database, which may include the previous sale history of the artwork, the previous sale history of works by the same artist and previous sale history of works by comparable artists. An average appreciation of works by the artist or by similar artists, and of works in similar medium are calculated from these comparisons.

Preferably, the algorithm of the present invention employs one of a plurality of evaluation formulas, based on the information input by the user and on the publicly available information in the database.

In accordance with one example of a possible evaluation formula, the average price of other works in the same medium by the same artist which were sold during the year of appraisal is multiplied by the size of the artwork, and the product is divided by the multiplication of the number of times the work has been sold by the average size of works in the same medium by the same artist. The resulting value is the appraisal value of the artwork.

In accordance with another example of a possible evaluation formula, the average price of works in the same medium but by different artists, which were produced in the same year as the appraised artwork and sold during the year of appraisal is multiplied by the size of the artwork. The resulting product is divided by the multiplication of the number of times the work has been sold by the average size of works in the same medium by the same artist. The resulting value is the appraisal value of the artwork.

In accordance with yet another example of a possible evaluation formula, the price at which the artwork was sold in the past is multiplied by an average appreciation of sale prices of works by the same artist which were sold since the last time the appraised work was sold, and the resulting product is the appraisal value of the artwork.

Inasmuch as the appraisal need not be based on information regarding the current owners of the works or the location of the works, it can be carried out anonymously and without interaction with the owners of the works or disclosure by the owners of their identity and/or location. This may be done by channeling information regarding the works through one or more intermediaries, who preferably are affiliated with the operators of the database, but need not necessarily be. The intermediary should be trusted by both the owner of the work and by the operator of the database in order to enhance credibility of the resulting appraisal.

Optionally, the database 360 may be employed to generate an anonymous virtual catalog, including the resulting appraisals of the works in the catalog, which may be pushed or otherwise made available via the computer network to the collectors who provided the particulars of the works in their collections to the database, preferably not directly but instead via intermediaries 355, 357 and 359, and/or to other entities, such as, for example, dealers and museums, typically via a computer 364. The entire catalog need not be made available to all entities. For example, some entities may wish to receive information only regarding works of specific artists or belonging to specific periods.

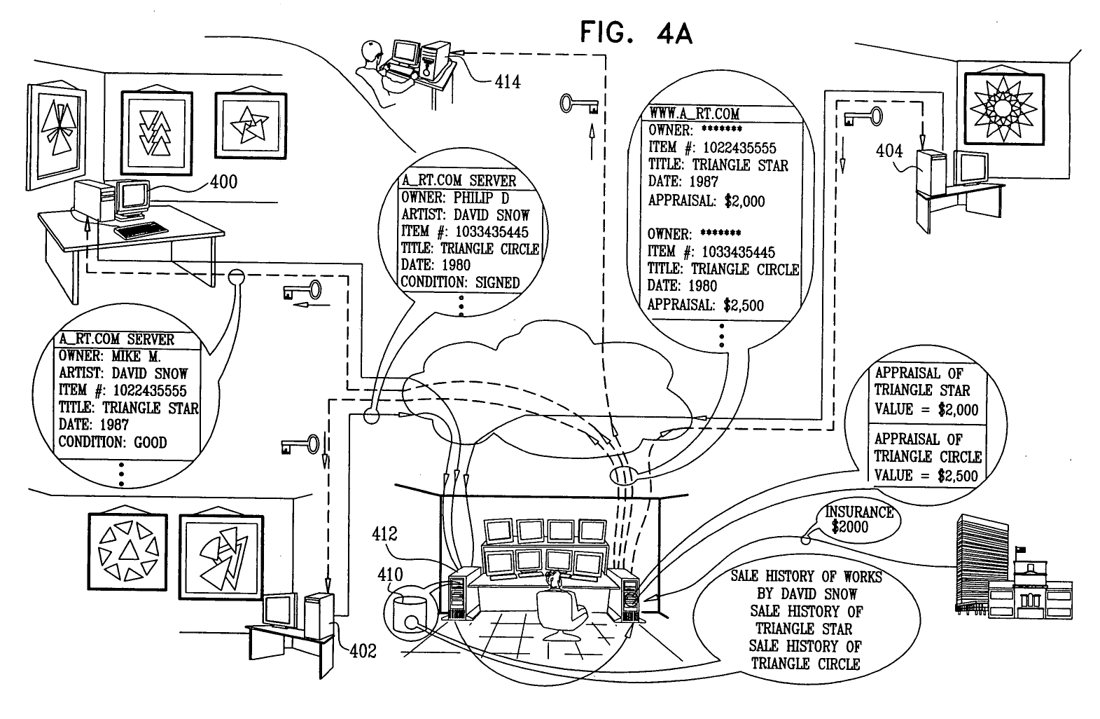

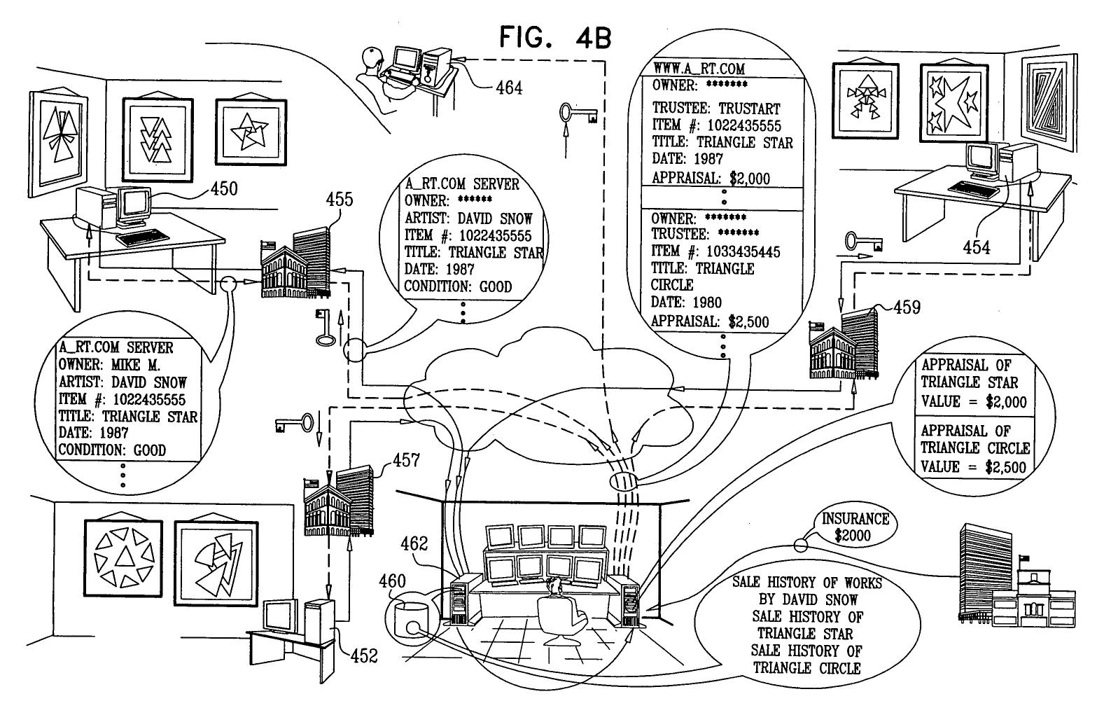

Reference is now made to FIG. 4A, which is a simplified pictorial illustration of a system and methodology for effecting insurance of non-fungible goods, such as works of fine art, based on automated appraisal without disclosing information relating to the ownership of such non-fungible goods and to FIG. 4B, which is a simplified pictorial illustration of a double-blind system and methodology for effecting insurance of non-fungible goods, such as works of fine art, based on automated appraisal.

As shown generally in FIG. 4A, there is provided a method for computerized appraisal of unique items of art and insurance coverage thereof, the method including entering particulars of at least one unique item of art held by at least one collector into a database, which particulars include at least one of artist identifiers, date identifiers and relevant recent sale histories of related items of art, without entering into the database identifiers of the at least one collector, employing at least one formula for computerized appraisal of the at least one unique item of art and employing the computerized appraisal for establishing insurance coverage of the at least one unique item of art, wherein the identifiers of the at least one collector are not provided to a provider of the insurance coverage.

As seen in FIG. 4A, a plurality of collectors, using respective computers 400, 402 and 404 communicate via a computer network, such as the Internet, with one or more central databases 410 residing on one or more servers 412. They preferably provide to the database 410 particulars of the non-fungible goods, here, for example, works of fine art, in their collections. These particulars may include, for example, identification of the works by title, artist and date or period, the condition of the work, its dimensions and the provenance thereof. The collectors may indicate a price at which they would be willing to sell one or more works and/or one or more works that they would be willing to trade therefor. They may or may not provide information which indicates their identity or the location of the works. The database 410 preferably also contains publicly available information, such as information from treatises and journals, which may be relevant to the valuation of a work or collection of works.

The database 410 is preferably employed by an art appraisal algorithm which employs the information contained therein to automatically generate an appraisal of one or more works in the database. Preferably, a user provides input information regarding the work of art, such as the artist name, title, size, shape, medium of the artwork, date or period, provenance of the art work, purchase date and price, and an indication whether the artwork is signed.

The input information is preferably compared to sale history data contained in the database, which may include the previous sale history of the artwork, the previous sale history of works by the same artist and previous sale history of works by comparable artists. An average appreciation of works by the artist or by similar artists, and of works in similar medium are calculated from these comparisons.

Preferably, the algorithm of the present invention employs one of a plurality of evaluation formulas, based on the information input by the user and on the publicly available information in the database.

In accordance with one example of a possible evaluation formula, the average price of other works in the same medium by the same artist which were sold during the year of appraisal is multiplied by the size of the artwork, and the product is divided by the multiplication of the number of times the work has been sold by the average size of works in the same medium by the same artist. The resulting value is the appraisal value of the artwork.

In accordance with another example of a possible evaluation formula, the average price of works in the same medium but by different artists, which were produced in the same year as the appraised artwork and sold during the year of appraisal is multiplied by the size of the artwork. The resulting product is divided by the multiplication of the number of times the work has been sold by the average size of works in the same medium by the same artist. The resulting value is the appraisal value of the artwork.

In accordance with yet another example of a possible evaluation formula, the price at which the artwork was sold in the past is multiplied by an average appreciation of sale prices of works by the same artist which were sold since the last time the appraised work was sold, and the resulting product is the appraisal value of the artwork.

Inasmuch as the appraisal need not be based on information regarding the current owners of the works or the location of the works, it can be carried out anonymously and without interaction with the owners of the works or disclosure by the owners of their identity and/or location. This may be done by channeling information regarding the works through one or more intermediaries, who preferably are affiliated with the operators of the database, but need not necessarily be. The intermediary should be trusted by both the owner of the work and by the operator of the database in order to enhance credibility of the resulting appraisal.

In accordance with a preferred embodiment of the present invention, one or more insurance underwriters preferably provide insurance cover based on the computerized appraisal and issues an insurance policy covering the works. In a case where the location of the works and the level of security provided therefor is now known to the insurance underwriter, the insurance policy may specify certain conditions as to location and security. Fulfillment of these conditions may remain the responsibility of the owner of the works or alternatively a trusted intermediary may provide representations as to location and level of security sufficient to satisfy the insurance underwriter.

Optionally, the database 410 may be employed to generate an anonymous virtual catalog, including the resulting appraisals of the works in the catalog, which may be pushed or otherwise made available via the computer network to the collectors who provided the particulars of the works in their collections to the database, such as, for example, dealers and museums, typically via a computer 414. The entire catalog need not be made available to all entities. For example, some entities may wish to receive information only regarding works of specific artists or belonging to specific periods.

Reference is now made to FIG. 4B, which is a simplified pictorial illustration of a double-blind system and methodology for effecting insurance of non-fungible goods, such as works of fine art, based on automated appraisal.

As shown generally in FIG. 4B, there is provided a method for anonymous insurance coverage of unique items, the method including entering particulars of at least one unique item of art held by at least one collector into a database, including at least one of artist identifiers, date identifiers and relevant recent sale histories of related items of art, without providing to the database identifiers of the at least one collector, employing at least one formula for computerized appraisal of the at least one unique item of art and employing the computerized appraisal for establishing insurance coverage of the at least one unique item of art, including establishing an insurance contract for the at least one unique item of art through at least one double blind intermediary, trusted by at least one party to the insurance contract.

As seen in FIG. 4B, a plurality of collectors, using respective computers 450, 452 and 454 communicate via a computer network, such as the Internet, with respective trusted intermediaries 455, 457 and 459, such as fiduciaries or trustees. These trusted intermediaries communicate in turn via the same or a different computer network with one or more central databases 460 residing on one or more servers 462. The collectors preferably provide to their respective trusted intermediaries 455, 457 and 459 particulars of the non-fungible goods, here, for example, works of fine art, in their collections. These particulars may include, for example, identification of the works by title, artist and date or period, the condition of the work, the size of the work, the medium and the provenance thereof. The collectors may indicate a price at which they would be willing to sell one or more works and/or one or more works that they would be willing to trade therefor. They preferably provide to their trusted intermediaries information which indicates their identity and the location of the works.

It is appreciated that the trusted intermediaries 455, 457 and 459 are trusted by the collectors and a single intermediary may act as a trusted intermediary for more than one collector. The trusted intermediaries preferably provide to the database 460 particulars of the non-fungible goods, here, for example, works of fine art, in the collections of their respective collector clients. These particulars may include, for example, identification of the works by title, artist and date or period, the condition of the work, size of the work, the medium and the provenance thereof and a price at which the collectors would be willing to sell one or more works and/or one or more works that they would be willing to trade therefor. They do not provide information which indicates the identity and/or location of their collector clients.

The database 460 is preferably employed by an art appraisal algorithm which employs the information contained therein to automatically generate an appraisal of one or more works in the database. Preferably, a user provides input information regarding the work of art, such as the artist name, title, size, shape, medium of the artwork, date or period, provenance of the art work, purchase date and price, and an indication whether the artwork is signed.

The input information is preferably compared to sale history data contained in the database, which may include the previous sale history of the artwork, the previous sale history of works by the same artist and previous sale history of works by comparable artists. An average appreciation of works by the artist or by similar artists, and of works in similar medium are calculated from these comparisons.

Preferably, the algorithm of the present invention employs one of a plurality of evaluation formulas, based on the information input by the user and on the publicly available information in the database.

In accordance with one example of a possible evaluation formula, the average price of other works in the same medium by the same artist which were sold during the year of appraisal is multiplied by the size of the artwork, and the product is divided by the multiplication of the number of times the work has been sold by the average size of works in the same medium by the same artist. The resulting value is the appraisal value of the artwork.

In accordance with another example of a possible evaluation formula, the average price of works in the same medium but by different artists, which were produced in the same year as the appraised artwork and sold during the year of appraisal is multiplied by the size of the artwork. The resulting product is divided by the multiplication of the number of times the work has been sold by the average size of works in the same medium by the same artist. The resulting value is the appraisal value of the artwork.

In accordance with yet another example of a possible evaluation formula, the price at which the artwork was sold in the past is multiplied by an average appreciation of sale prices of works by the same artist which were sold since the last time the appraised work was sold, and the resulting product is the appraisal value of the artwork.

Inasmuch as the appraisal need not be based on information regarding the current owners of the works or the location of the works, it can be carried out anonymously and without interaction with the owners of the works or disclosure by the owners of their identity and/or location. This may be done by channeling information regarding the works through one or more intermediaries, who preferably are affiliated with the operators of the database, but need not necessarily be. The intermediary should be trusted by both the owner of the work and by the operator of the database in order to enhance credibility of the resulting appraisal.

In accordance with a preferred embodiment of the present invention, one or more insurance underwriters preferably provide insurance cover based on the computerized appraisal and issues an insurance policy covering the works. In a case where the location of the works and the level of security provided therefor is now known to the insurance underwriter, the insurance policy may specify certain conditions as to location and security. Fulfillment of these conditions may remain the responsibility of the owner of the works or alternatively a trusted intermediary may provide representations as to location and level of security sufficient to satisfy the insurance underwriter.

Optionally, the database 460 may be employed to generate an anonymous virtual catalog, including the resulting appraisals of the works in the catalog, which may be pushed or otherwise made available via the computer network to the collectors who provided the particulars of the works in their collections to the database, preferably not directly but instead via intermediaries 455, 457 and 459, and/or to other entities, such as, for example, dealers and museums, typically via a computer 464. The entire catalog need not be made available to all entities. For example, some entities may wish to receive information only regarding works of specific artists or belonging to specific periods.

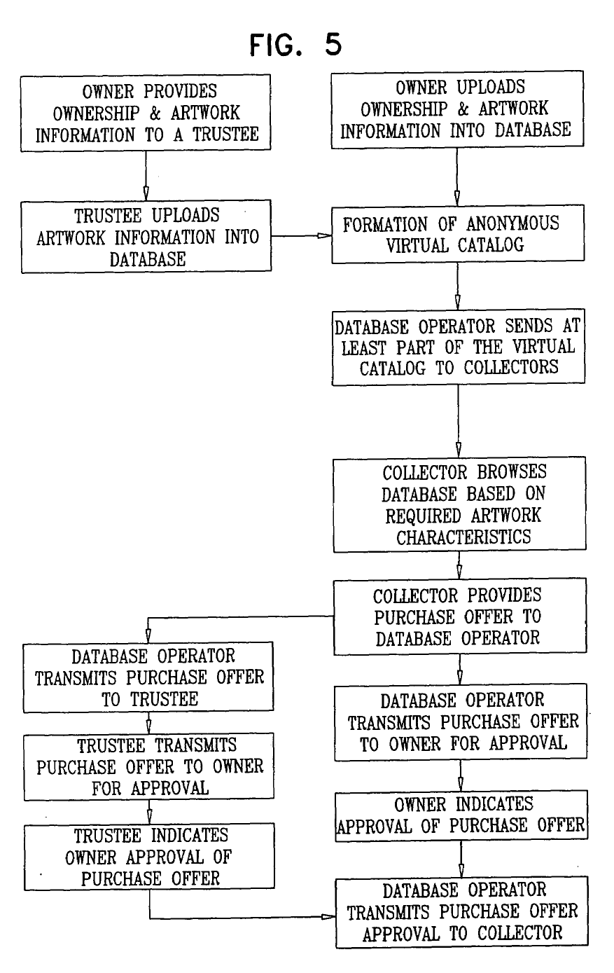

Reference is now made to FIG. 5, which is a simplified flowchart illustrating functionality employed in the embodiment of FIGS. 1A and 1B. As seen in FIG. 5, an owner of fungible goods, such as artworks, uploads information regarding the works, and ownership information into a database. The ownership identity information is stored in the database. Alternatively, in accordance with the embodiment described hereinabove with reference to FIG. 1B, the owner may provide information regarding the artwork and ownership information to a trustee, which then uploads the information, excluding any information relating to ownership identity information, into the database.

The uploaded information is preferably included in a virtual catalog which does not include ownership identity information, which is provided to collectors. A collector may search the catalog for a desired artwork, based on required characteristics of the artwork, such as the artist, the year of production or the dimensions of the artwork. As described hereinabove with reference to FIGS. 1A and 1B, the catalog may be provided to collectors in its entirety, or, alternatively, only sections that interest a given collector may be provided thereto.

Preferably, the collector provides a purchase offer to an operator of the database, which offer may or may not include an offered purchase price.

The database operator then transmits the purchase offer to the owner of the artwork, for the owner's approval. Alternatively, in accordance with the embodiment described hereinabove with reference to FIG. 1B, the database operator may transmit the purchase offer to the trustee, which forwards the purchase offer to the owner for approval, and indicates the approval of the purchase offer, provided by the owner, back to the database operator.

Once the owner approves the purchase offer, the database operator indicates to the collector that his purchase offer was approved. Thus, direct or indirect contact is formed between the collector and the work owner, possibly via at least one intermediary.

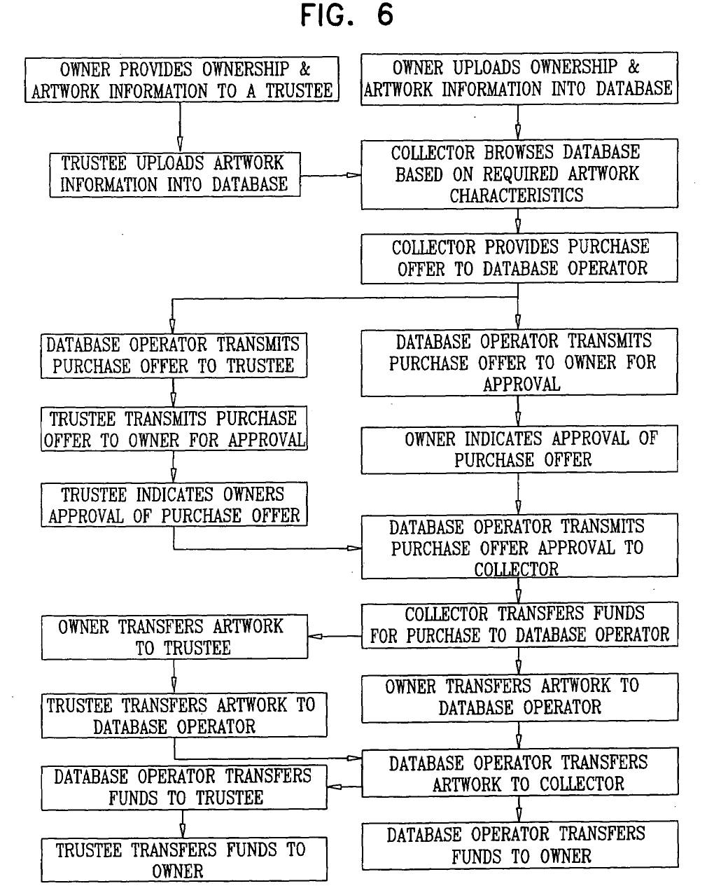

Reference is now made to FIG. 6, which is a simplified flowchart illustrating functionality employed in the embodiment of FIGS. 2A and 2B. As seen in FIG. 6, an owner of fungible goods, such as artworks, uploads information regarding the works, and ownership information into a database. The ownership identity information is stored in the database. Alternatively, in accordance with the embodiment described hereinabove with reference to FIG. 2B, the owner may provide information regarding the artwork and ownership information to a trustee, which then uploads the information, excluding any information relating to ownership identity information, into the database.

A collector may browse the database for a desired work, based on required characteristics of the artwork, such as the artist, the year of production or the dimensions of the artwork. Preferably, the collector provides a purchase offer to an operator of the database, which offer may or may not include an offered purchase price.

The database operator then transmits the purchase offer to the owner of the artwork, for the owner's approval. Alternatively, in accordance with the embodiment described hereinabove with reference to FIG. 2B, the database operator may transmit the purchase offer to the trustee, which forwards the purchase offer to the owner for approval, and indicates the approval of the purchase offer, provided by the owner, back to the database operator.

Once the owner approves the purchase offer, the database operator indicates to the collector that his purchase offer was approved. The collector then transfers funds for the purchase of the artwork to the database operator, and the owner transmits the artwork to the database operator. In accordance with the embodiment of FIG. 2B, the owner transmits the artwork to the trustee, which in turn transmits the artwork to the database operator.

At his discretion, the database operator transfers the artwork to the collector and the received finds to the owner of the artwork, thereby concluding the transaction. Alternatively, the finds for the artwork are transferred to the trustee which transfers them to the owner of the artwork.

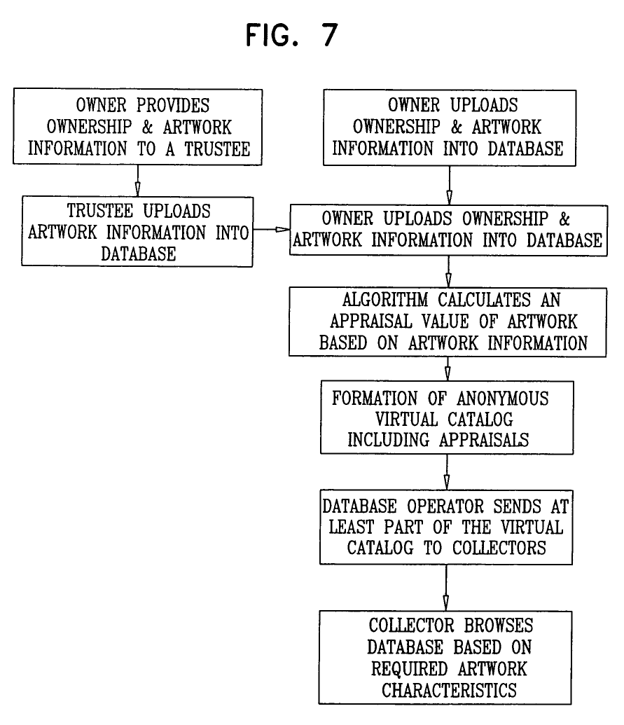

Reference is now made to FIG. 7, which is a simplified flowchart illustrating functionality employed in the embodiment of FIGS. 3A and 3B. As seen in FIG. 7, an owner of fungible goods, such as artworks, uploads information regarding the works, and ownership information into a database. The ownership identity information is stored in the database. Alternatively, in accordance with the embodiment described hereinabove with reference to FIG. 3B, the owner may provide information regarding the artwork and ownership information to a trustee, which then uploads the information, excluding any information relating to ownership identity information, into the database.

In accordance with the embodiments of FIGS. 3A and 3B, the artwork is automatically appraised by an appraisal algorithm, described hereinabove with reference to FIGS. 3A and 3B. The appraisal algorithm preferably appraises the artwork based on the uploaded artwork information and on data previously stored in the database, but not on ownership identity information. The result of the appraisal algorithm is also stored in the database.

The uploaded information and the appraisal value are preferably included in a virtual catalog which does not include ownership identity information, which is provided to collectors. A collector may search the catalog for a desired artwork, based on required characteristics of the artwork, such as the artist, the year of production or the dimensions of the artwork.

The collector may then contact the owner of the artwork or purchase the artwork, in a similar manner to that described hereinabove with reference to FIGS. 1A-2B.

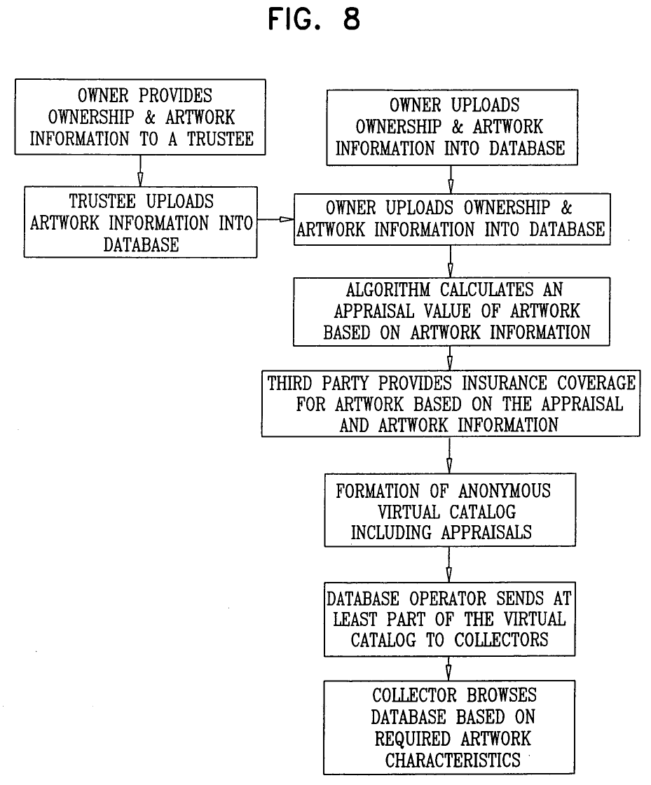

Reference is now made to FIG. 8, which is a simplified flowchart illustrating functionality employed in the embodiment of FIGS. 4A and 4B. As seen in FIG. 8, an owner of fungible goods, such as artworks, uploads information regarding the works, and ownership information into a database. The ownership identity information is stored in the database. Alternatively, in accordance with the embodiment described hereinabove with reference to FIG. 4B, the owner may provide information regarding the artwork and ownership information to a trustee, which then uploads the information, excluding any information relating to ownership identity information, into the database.

In accordance with the embodiments of FIGS. 4A and 4B, the artwork is automatically appraised by an appraisal algorithm, described hereinabove with reference to FIGS. 4A and 4B. The appraisal algorithm preferably appraises the artwork based on the uploaded artwork information and on data previously stored in the database, but not on ownership identity information. The result of the appraisal algorithm is also stored in the database.

In accordance with the embodiments of FIGS. 4A and 4B, an intermediary may provide insurance or financial escrow for the artwork, based on the appraisal value and knowing the information of the artwork, but not on the ownership identity information.

Thus, in accordance with a preferred embodiment of the present invention, insurance coverage for a work of art can be obtained, while the identity of the owner remains unknown to the insurance provider.

A virtual catalog including particulars of the artworks may be generated, and an art collector may browse the virtual catalog, and contact the owners or representatives thereof, in a similar manner to that described hereinabove with reference to FIGS. 1A-2B.

It will be appreciated by persons skilled in the art that the present invention is not limited by the claims which follow but includes also combinations and sub-combinations of the subject matter described hereinabove as well as variations thereof which would occur to persons skilled in the art upon reading the foregoing description and which are not in the prior art.

1. A method for anonymous computerized commerce in non-fungible goods, the method comprising:
entering into a database particulars of non-fungible goods held by at least one of potential buyers and sellers, without providing to said database identifiers of said at least one of potential buyers and sellers;
employing said database to match potential buyers with potential sellers of non-fungible goods based on similarities between non-fungible goods at least potentially available for sale by potential sellers and non-fungible goods held by potential buyers; and
establishing contact with at least one of potential buyers and sellers.

2. A method according to claim 1 and wherein said particulars include at least one of identification of said non-fungible goods by title, artist identifiers, date identifiers, period identifiers, condition identifiers and provenance identifiers.

3. A method according to claim 1 and wherein said entering also comprises entering into said database at least one of a price at which said potential sellers would be willing to sell said non-fungible goods and an identification of other non-fungible goods for which said potential sellers would be willing to trade said non-fungible goods.

4. A method according to claim 2 and wherein said entering also comprises entering into said database at least one of a price at which said potential sellers would be willing to sell said non-fungible goods and an identification of other non-fungible goods for which said potential sellers would be willing to trade said non-fungible goods.

5. A method according to claim 1 and wherein said employing comprises:
employing said database to generate an anonymous virtual catalog of non-fungible goods; and
making at least part of said anonymous virtual catalog available to said at least one of potential buyers and sellers.

6. A method according to claim 2 and wherein said employing comprises:
employing said database to generate an anonymous virtual catalog of non-fungible goods; and
making at least part of said anonymous virtual catalog available to said at least one of potential buyers and sellers.

7. A method according to claim 3 and wherein said employing comprises:
employing said database to generate an anonymous virtual catalog of non-fungible goods; and
making at least part of said anonymous virtual catalog available to said at least one of potential buyers and sellers.

8. A method according to claim 4 and wherein said employing comprises:
employing said database to generate an anonymous virtual catalog of non-fungible goods; and
making at least part of said anonymous virtual catalog available to said at least one of potential buyers and sellers.

9. A method according to claim 1 and wherein said establishing contact comprises establishing contact between said potential buyers and said potential sellers via at least one intermediary.

10. A method according to claim 2 and wherein said establishing contact comprises establishing contact between said potential buyers and said potential sellers via at least one intermediary.

11. A method according to claim 3 and wherein said establishing contact comprises establishing contact between said potential buyers and said potential sellers via at least one intermediary.

12. A method according to claim 5 and wherein said establishing contact comprises establishing contact between said potential buyers and said potential sellers via at least one intermediary.

13. A method according to claim 9, and wherein said at least one intermediary comprises an operator of said database.

14. A method according to claim 10, and wherein said at least one intermediary comprises an operator of said database.

15. A method according to claim 1 1, and wherein said at least one intermediary comprises an operator of said database.

16. A method according to claim 12, and wherein said at least one intermediary comprises an operator of said database.

17. A method according to claim 1 and wherein said entering comprises communicating said particulars to said database via a network.

18. A method according to claim 1 and wherein said at least one of potential buyers and sellers comprises at least one of collectors, museums and dealers in non-fungible goods.

19. A method according to claim 1 and wherein said non-fungible goods comprise works of fine art.

20. A method according to claim 1 and wherein said establishing contact comprises providing to said potential buyers identifying information for said potential sellers.

21. A method for double-blind anonymous computerized commerce in non-fungible goods, the method comprising:
entering into a database particulars of non-fungible goods held by at least one of potential buyers and sellers, without providing to said database identifiers of said at least one of potential buyers and sellers;
employing said database to match potential buyers with potential sellers of non-fungible goods based on similarities between non-fungible goods at least potentially available for sale by potential sellers and non-fungible goods held by potential buyers; and
establishing contact with at least one of potential buyers and sellers through a double blind intermediary.

22. A method according to claim 21 and wherein said particulars include at least one of identification of said non-fungible goods by title, artist identifiers, date identifiers, period identifiers, condition identifiers and provenance identifiers.

23. A method according to claim 21 and wherein said entering also comprises entering into said database at least one of a price at which said potential sellers would be willing to sell -said non-fungible goods and an identification of other non-fungible goods for which said potential sellers would be willing to trade said non-fungible goods.

24. A method according to claim 22 and wherein said entering also comprises entering into said database at least one of a price at which said potential sellers would be willing to sell said non-fungible goods and an identification of other non-fungible goods for which said potential sellers would be willing to trade said non-fungible goods.

25. A method according to claim 21 and wherein said entering comprises:
communicating said particulars to at least one trusted intermediary; and
entering said particulars into said database by said at least one trusted intermediary.

26. A method according to claim 22 and wherein said entering comprises:
communicating said particulars to at least one trusted intermediary; and
entering said particulars into said database by said at least one trusted intermediary.

27. A method according to claim 23 and wherein said entering comprises:
communicating said particulars to at least one trusted intermediary; and
entering said particulars into said database by said at least one trusted intermediary.

28. A method according to claim 25 and wherein said communicating also comprises communicating to said at least one trusted intermediary said identifiers of said at least one of potential buyers and sellers.

29. A method according to claim 26 and wherein said communicating also comprises communicating to said at least one trusted intermediary said identifiers of said at least one of potential buyers and sellers.

30. A method according to claim 27 and wherein said communicating also comprises communicating to said at least one trusted intermediary said identifiers of said at least one of potential buyers and sellers.

31. A method according to claim 21 and wherein said employing comprises:
employing said database to generate an anonymous virtual catalog of non-fungible goods; and
making at least part of said anonymous virtual catalog available to said at least one of potential buyers and sellers.

32. A method according to claim 22 and wherein said employing comprises:
employing said database to generate an anonymous virtual catalog of non-fungible goods; and
making at least part of said anonymous virtual catalog available to said at least one of potential buyers and sellers.

33. A method according to claim 23 and wherein said employing comprises:
employing said database to generate an anonymous virtual catalog of non-fungible goods; and
making at least part of said anonymous virtual catalog available to said at least one of potential buyers and sellers.

34. A method according to claim 25 and wherein said employing comprises:
employing said database to generate an anonymous virtual catalog of non-fungible goods; and
making at least part of said anonymous virtual catalog available to said at least one of potential buyers and sellers.

35. A method according to claim 31 and wherein said making comprises making said at least part of said anonymous virtual catalog available to at least one trusted intermediary of said at least one of potential buyers and sellers.

36. A method according to claim 32 and wherein said making comprises making said at least part of said anonymous virtual catalog available to at least one trusted intermediary of said at least one of potential buyers and sellers.

37. A method according to claim 33 and wherein said making comprises making said at least part of said anonymous virtual catalog available to at least one trusted intermediary of said at least one of potential buyers and sellers.

38. A method according to claim 34 and wherein said making comprises making said at least part of said anonymous virtual catalog available to at least one trusted intermediary of said at least one of potential buyers and sellers.

39. A method according to claim 21 and wherein said at least one of potential buyers and sellers comprises at least one of collectors, museums and dealers in non-fungible goods.

40. A method according to claim 21 and wherein said non-fungible goods comprise works of fine art.

41. A method for anonymous computerized commerce in non-fungible goods, the method comprising:
entering into a database particulars of non-fungible goods held by at least one of potential buyers and sellers, without providing to said database identifiers of said at least one of potential buyers and sellers;
employing said database to match potential buyers with potential sellers of non-fungible goods based on similarities between non-fungible goods at least potentially available for sale by potential sellers and non-fungible goods held by potential buyers; and
guaranteeing the transaction using at least one fiduciary.

42. A method according to claim 41 and wherein said particulars include at least one of identification of said non-fungible goods by title, artist identifiers, date identifiers, period identifiers, condition identifiers and provenance identifiers.

43. A method according to claim 41 and wherein said entering also comprises entering into said database at least one of a price at which said potential sellers would be willing to sell said non-fungible goods and an identification of other non-fungible goods for which said potential sellers would be willing to trade said non-fungible goods.

44. A method according to claim 42 and wherein said entering also comprises entering into said database at least one of a price at which said potential sellers would be willing to sell said non-fungible goods and an identification of other non-fungible goods for which said potential sellers would be willing to trade said non-fungible goods.

45. A method according to claim 41 and wherein said employing comprises:
employing said database to generate an anonymous virtual catalog of non-fungible goods; and
making at least part of said anonymous virtual catalog available to said at least one of potential buyers and sellers.

46. A method according to claim 42 and wherein said employing comprises:
employing said database to generate an anonymous virtual catalog of non-fungible goods; and
making at least part of said anonymous virtual catalog available to said at least one of potential buyers and sellers.

47. A method according to claim 43 and wherein said employing comprises:
employing said database to generate an anonymous virtual catalog of non-fungible goods; and
making at least part of said anonymous virtual catalog available to said at least one of potential buyers and sellers.

48. A method according to claim 41 and wherein said at least one of potential buyers and sellers comprises at least one of collectors, museums and dealers in non-fungible goods.

49. A method according to claim 41 and wherein said non-fungible goods comprise works of fine art.

50. A method according to claim 41 and wherein said guaranteeing comprises providing said non-fungible goods to said at least one fiduciary by a selling party and providing funds for said non-fungible goods to said at least one fiduciary by a buying party.

51. A method according to claim 41 and wherein said at least one fiduciary comprises an operator of said database.

52. A method according to claim 41 and wherein said entering comprises communicating said particulars to said database via a network.

53. A method according to claim 41 and wherein said guaranteeing comprises said at least one fiduciary providing identifying information of a buying party of said non-fungible goods to a selling party thereof.

54. A method according to claim 42 and wherein said guaranteeing comprises said at least one fiduciary providing identifying information of a buying party of said non-fungible goods to a selling party thereof.

55. A method according to claim 45 and wherein said guaranteeing comprises said at least one fiduciary providing identifying information of a buying party of said non-fungible goods to a selling party thereof.

56. A method for double-blind anonymous computerized commerce in non-fungible goods, the method comprising:
entering into a database particulars of non-fungible goods held by at least one of potential buyers and sellers, without providing to said database identifiers of said at least one of potential buyers and sellers;
employing said database to match potential buyers with potential sellers of non-fungible goods based on similarities between non-fungible goods at least potentially available for sale by potential sellers and non-fungible goods held by potential buyers; and
guaranteeing the transaction using at least two double-blind fiduciaries.

57. A method according to claim 56 and wherein said particulars include at least one of identification of said non-fungible goods by title, artist identifiers, date identifiers, period identifiers, condition identifiers and provenance identifiers.

58. A method according to claim 56 and wherein said entering also comprises entering into said database at least one of a price at which said potential sellers would be willing to sell said non-fungible goods and an identification of other non-fungible goods for which said potential sellers would be willing to trade said non-fungible goods.

59. A method according to claim 56 and wherein said entering comprises:
communicating said particulars to at least one trusted intermediary; and
entering said particulars into said database by said at least one trusted intermediary.

60. A method according to claim 57 and wherein said entering comprises:
communicating said particulars to at least one trusted intermediary; and
entering said particulars into said database by said at least one trusted intermediary.

61. A method according to claim 58 and wherein said entering comprises:
communicating said particulars to at least one trusted intermediary; and
entering said particulars into said database by said at least one trusted intermediary.

62. A method according to claim 59 and wherein said communicating also comprises communicating to said at least one trusted intermediary said identifiers of said at least one of potential buyers and sellers.

63. A method according to claim 60 and wherein said communicating also comprises communicating to said at least one trusted intermediary said identifiers of said at least one of potential buyers and sellers.

64. A method according to claim 61 and wherein said communicating also comprises communicating to said at least one trusted intermediary said identifiers of said at least one of potential buyers and sellers.

65. A method according to claim 56 and wherein said employing comprises:
employing said database to generate an anonymous virtual catalog of non-fungible goods; and
making at least part of said anonymous virtual catalog available to said at least one of potential buyers and sellers.

66. A method according to claim 65 and wherein said making comprises making said at least part of said anonymous virtual catalog available to at least one trusted intermediary of said at least one of potential buyers and sellers.

67. A method according to claim 56 and wherein said at least one of potential buyers and sellers comprises at least one of collectors, museums and dealers in non-fungible goods.

68. A method according to claim 56 and wherein said non-fungible goods comprise works of fine art.

69. A method according to claim 56 and wherein said guaranteeing comprises:
providing said non-fungible goods to a first of said at least two double blind fiduciaries by a selling party;
providing funds for said non-fungible goods to a second of said at least two double blind fiduciaries by a buying party; and
exchanging said non-fungible goods and said funds between said first and second of said at least two double blind fiduciaries.

70. A method according to claim 57 and wherein said guaranteeing comprises:
providing said non-fungible goods to a first of said at least two double blind fiduciaries by a selling party;
providing funds for said non-fungible goods to a second of said at least two double blind fiduciaries by a buying party; and
exchanging said non-fungible goods and said funds between said first and second of said at least two double blind fiduciaries.

71. A method for computerized appraisal of unique items of art, the method comprising:
entering particulars of at least one unique item of art held by at least one collector into a database, which particulars include at least one of artist identifiers, date identifiers and relevant recent sale histories of related items of art without entering into said database identifiers of said at least one collector; and
employing at least one formula for computerized appraisal of said at least one unique item of art.

72. A method according to claim 71 and wherein said particulars of said at least one unique item of art include at least one of identification of said unique item of art by title, artist identifiers, date identifiers, period identifiers, condition identifiers and provenance identifiers.

73. A method according to claim 71 and wherein said entering comprises communicating said particulars of said at least one unique item of art to said database via a network.

74. A method according to claim 72 and wherein said entering comprises communicating said particulars of said at least one unique item of art to said database via a network.

75. A method according to claim 71 and also comprising, prior to said entering, obtaining said relevant recent sale histories of related items of art from at least one of treatises and journals.

76. A method according to claim 72 and also comprising, prior to said entering, obtaining said relevant recent sale histories of related items of art from at least one of treatises and journals.

77. A method according to claim 71 and also comprising, prior to said employing at least one formula:
comparing said particulars of said at least one unique item of art with at least one of previously obtained particulars of related items of art, recent sale history of said at least one unique item of art, particulars of other items of art of the artist who created said at least one unique item of art and said relevant recent sale histories of related items of art; and
calculating an average appreciation of said related items of art.

78. A method according to claim 77 and wherein said at least one formula comprises the steps of:
multiplying an average price of said other items of art of said artist in the same medium as said at least one unique item of art by a metric representing the size of said at least one unique item of art to give a first result;
multiplying a number of sales of said at least one unique item of art by a metric representing an average size of said other items of art of said artist in the same medium to give a second result; and
dividing said first result by said second result.

79. A method according to claim 77 and wherein said at least one formula comprises the steps of:
multiplying an average price of other items of art in the same medium and created in the same year as said at least one unique item of art but created by an artist other than said artist by a metric representing the size of said at least one unique item of art to give a first result;
multiplying a number of sales of said at least one unique item of art by a metric representing an average size of said other items of art of said artist in the same medium to give a second result; and
dividing said first result by said second result.

80. A method according to claim 77 and wherein said at least one formula comprises multiplying a metric representing a price at which said at least one unique item of art has been sold in the past by a metric representing an average of sale prices of other items of art created by said artist sold since a previous sale of said at least one unique item of art.

81. A method for double-blind computerized appraisal of unique items of art, the method comprising:
entering particulars of at least one unique item of art held by at least one collector into a database, which particulars include at least one of artist identifiers, date identifiers and relevant recent sale histories of related items of art using at least one double-blind fiduciary; and
employing at least one formula for computerized appraisal of said at least one unique item of art.

82. A method according to claim 81 and wherein said particulars of said at least one unique item of art include at least one of identification of said unique item of art by title, artist identifiers, date identifiers, period identifiers, condition identifiers and provenance identifiers.

83. A method according to claim 81 and wherein identifiers of said at least one collector are not entered into said database.

84. A method according to claim 82 and wherein identifiers of said at least one collector are not entered into said database.

85. A method according to claim 81 and wherein said entering comprises:
communicating said particulars to said at least one double-blind fiduciary; and
entering said particulars into said database by said at least one double-blind fiduciary.

86. A method according to claim 82 and wherein said entering comprises:
communicating said particulars to said at least one double-blind fiduciary; and
entering said particulars into said database by said at least one double-blind fiduciary.

87. A method according to claim 85 and wherein said communicating also comprises communicating to said at least one double-blind said identifiers of said at least one collector.

88. A method according to claim 86 and wherein said communicating also comprises communicating to said at least one double-blind said identifiers of said at least one collector.

89. A method according to claim 81 and wherein said entering comprises communicating said particulars of said at least one unique item of art to said database via a network.

90. A method according to claim 81 and also comprising, prior to said entering, obtaining said relevant recent sale histories of related items of art from at least one of treatises and journals.

91. A method according to claim 81 and also comprising, prior to said employing at least one formula:
comparing said particulars of said at least one unique item of art with at least one of previously obtained particulars of related items of art, recent sale history of said at least one unique item of art, particulars of other items of art of the artist who created said at least one unique item of art and said relevant recent sale histories of related items of art; and
calculating an average appreciation of said related items of art.

92. A method according to claim 91 and wherein said at least one formula comprises the steps of:
multiplying an average price of said other items of art of said artist in the same medium as said at least one unique item of art by a metric representing the size of said at least one unique item of art to give a first result;
multiplying a number of sales of said at least one unique item of art by a metric representing an average size of said other items of art of said artist in the same medium to give a second result; and
dividing said first result by said second result.

93. A method according to claim 91 and wherein said at least one formula comprises the steps of:
multiplying an average price of other items of art in the same medium and created in the same year as said at least one unique item of art but created by an artist other than said artist by a metric representing the size of said at least one unique item of art to give a first result;
multiplying a number of sales of said at least one unique item of art by a metric representing an average size of said other items of art of said artist in the same medium to give a second result; and
dividing said first result by said second result.

94. A method according to claim 91 and wherein said at least one formula comprises multiplying a metric representing a price at which said at least one unique item of art has been sold in the past by a metric representing an average of sale prices of other items of art created by said artist sold since a previous sale of said at least one unique item of art.

95. A method for computerized appraisal of unique items of art and insurance coverage thereof, the method comprising:
entering particulars of at least one unique item of art held by at least one collector into a database, which particulars include at least one of artist identifiers, date identifiers and relevant recent sale histories of related items of art, without entering into said database identifiers of said at least one collector;
employing at least one formula for computerized appraisal of said at least one unique item of art; and
employing said computerized appraisal for establishing insurance coverage of said at least one unique item of art, wherein said identifiers of said at least one collector are not provided to a provider of said insurance coverage.

96. A method according to claim 95 and wherein said entering comprises communicating to said at least one trusted intermediary said identifiers of said at least one collector.

97. A method according to claim 95 and wherein said particulars of said at least one unique item of art include at least one of identification of said at least one unique item of art by title, artist identifier, date identifier, period identifier, condition identifier and provenance identifier.

98. A method according to claim 96 and wherein said particulars of said at least one unique item of art include at least one of identification of said at least one unique item of art by title, artist identifier, date identifier, period identifier, condition identifier and provenance identifier.

99. A method according to claim 95 and wherein said entering comprises communicating said particulars of said at least one unique item of art to said database via a network.

100. A method according to claim 95 and also comprising, prior to said entering, obtaining said relevant recent sale histories of related items of art from at least one of treatises and journals.

101. A method according to claim 95 and also comprising, prior to said employing at least one formula:
comparing said particulars of said at least one unique item of art with at least one of previously obtained particulars of related items of art, recent sale history of said at least one unique item of art, particulars of other items of art of the artist who created said at least one unique item of art and said relevant recent sale histories of related items of art; and
calculating an average appreciation of said related items of art.

102. A method according to claim 101 and wherein said at least one formula comprises the steps of:
multiplying an average price of said other items of art of said artist in the same medium as said at least one unique item of art by a metric representing the size of said at least one unique item of art to give a first result;
multiplying a number of sales of said at least one unique item of art by a metric representing an average size of said other items of art of said artist in the same medium to give a second result; and
dividing said first result by said second result.

103. A method according to claim 101 and wherein said at least one formula comprises the steps of:
multiplying an average price of other items of art in the same medium and created in the same year as said at least one unique item of art but created by an artist other than said artist by a metric representing the size of said at least one unique item of art to give a first result;
multiplying a number of sales of said at least one unique item of art by a metric representing an average size of said other items of art of said artist in the same medium to give a second result; and
dividing said first result by said second result.

104. A method according to claim 101 and wherein said at least one formula comprises multiplying a metric representing a price at which said at least one unique item of art has been sold in the past by a metric representing an average of sale prices of other items of art created by said artist sold since a previous sale of said at least one unique item of art.

105. A method for anonymous insurance coverage of unique items, the method comprising:
entering particulars of at least one unique item of art held by at least one collector into a database, including at least one of artist identifiers, date identifiers and relevant recent sale histories of related items of art, without providing to the database identifiers of said at least one collector;
employing at least one formula for computerized appraisal of said at least one unique item of art;
employing said computerized appraisal for establishing insurance coverage of said at least one unique item of art, including establishing an insurance contract for said at least one unique item of art through at least one double blind intermediary, trusted by at least one party to said insurance contract.

106. A method according to claim 105 and wherein said entering comprises:
communicating said particulars of said at least one unique item of art to said at least one double blind intermediary; and
entering said particulars of said at least one unique item of art into said database by said at least one double blind intermediary.

107. A method according to claim 106 and wherein said communicating also comprises communicating said identifiers of said at least one collector to said at least one double blind intermediary.

108. A method according to claim 105 and wherein said particulars of said at least one unique item of art include at least one of identification of said unique item of art by title, artist identifiers, date identifiers, period identifiers, condition identifiers and provenance identifiers.

109. A method according to claim 105 and wherein said entering comprises communicating said particulars of said at least one unique item of art to said database via a network.

110. A method according to claim 105 and also comprising, prior to said entering, obtaining said relevant recent sale histories of related items of art from at least one of treatises and journals.

111. A method according to claim 105 and also comprising, prior to said employing at least one formula:
comparing said particulars of said at least one unique item of art with at least one of previously obtained particulars of related items of art, recent sale history of said at least one unique item of art, particulars of other items of art of the artist who created said at least one unique item of art and said relevant recent sale histories of related items of art; and
calculating an average appreciation of said related items of art.

112. A method according to claim 111 and wherein said at least one formula comprises the steps of:
multiplying an average price of said other items of art of said artist in the same medium as said at least one unique item of art by a metric representing the size of said at least one unique item of art to give a first result;
multiplying a number of sales of said at least one unique item of art by a metric representing an average size of said other items of art of said artist in the same medium to give a second result; and
dividing said first result by said second result.

113. A method according to claim 11 1 and wherein said at least one formula comprises the steps of:
multiplying an average price of other items of art in the same medium and created in the same year as said at least one unique item of art but created by an artist other than said artist by a metric representing the size of said at least one unique item of art to give a first result;
multiplying a number of sales of said at least one unique item of art by a metric representing an average size of said other items of art of said artist in the same medium to give a second result; and
dividing said first result by said second result.

114. A method according to claim 111 and wherein said at least one formula comprises multiplying a metric representing a price at which said at least one unique item of art has been sold in the past by a metric representing an average of sale prices of other items of art created by said artist sold since a previous sale of said at least one unique item of art.
